(19) United States
(12) Patent Application Publication
(10) Pub. No.: US 2018/0368181 A1
(43) Pub. Date: Dec. 20, 2018

(54) METHOD AND USER EQUIPMENT FOR MONITORING RANDOM ACCESS RESPONSE, AND METHOD AND BASE STATION FOR TRANSMITTING RANDOM ACCESS RESPONSE

(71) Applicant: LG Electronics Inc., Seoul (KR)

(72) Inventors: Eunjong LEE, Seoul (KR); Sunyoung LEE, Seoul (KR)

(21) Appl. No.: 16/009,538

(22) Filed: Jun. 15, 2018

Related U.S. Application Data
(60) Provisional application No. 62/520,592, filed on Jun. 16, 2017.

(51) Int. Cl. H04W 74/08; H04W 24/08

(52) U.S. Cl. CPC H04W 74/08; H04W 84/042; H04W 24/08

(57) ABSTRACT

A user equipment (UE) in a wireless communication system receives configuration information for random access channel (RACH) resources. The UE transmits a first preamble of a random access procedure using a first RACH resource among the RACH resources based on the configuration information, and monitors a RAR message of the random access procedure based on a first random access radio network temporary identifier (RA-RNTI). In the present invention, the first RA-RNTI is computed based on an index of a time unit of the first RACH resource and an index of the first symbol of the first RACH resource, where each time unit consists of 14 symbols in a time domain, and the index of the first symbol of the first RACH resource is a non-negative integer value smaller than 14.

### CROSS-REFERENCE TO RELATED APPLICATIONS

This application claims the benefit of U.S. Provisional Application Ser. No. 62/520,592, filed on Jun. 16, 2017, the contents of which are all hereby incorporated by reference herein in their entirety.

### TECHNICAL FIELD

The present invention relates to a wireless communication system, and more particularly, to a method for monitoring/transmitting a random access response and an apparatus therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

As more and more communication devices demand larger communication capacity, there is a need for improved mobile broadband communication compared to existing RAT. Also, massive machine type communication (MTC), which provides various services by connecting many devices and objects, is one of the major issues to be considered in the next generation communication. In addition, a communication system design considering a service/UE sensitive to reliability and latency is being discussed. The introduction of next-generation RAT, which takes into account such advanced mobile broadband communication, massive MTC (mMCT), and ultra-reliable and low latency communication (URLLC), is being discussed.

### Technical Problem

Due to introduction of new radio communication technology, the number of user equipments (UEs) to which a BS should provide a service in a prescribed resource region increases and the amount of data and control information that the BS should transmit to the UEs increases. Since the amount of resources available to the BS for communication with the UE(s) is limited, a new method in which the BS efficiently receives/transmits uplink/downlink data and/or uplink/downlink control information using the limited radio resources is needed.

With development of technologies, overcoming delay or latency has become an important challenge. Applications whose performance critically depends on delay/latency are increasing. Accordingly, a method to reduce delay/latency compared to the legacy system is demanded.

Also, a method for transmitting/receiving signals effectively in a system supporting new radio access technology is required.

The technical objects that can be achieved through the present invention are not limited to what has been particularly described hereinabove and other technical objects not described herein will be more clearly understood by persons skilled in the art from the following detailed description.

### SUMMARY

In an aspect of the present invention, provided herein is a method for monitoring a random access response (RAR) by a user equipment (UE) in a wireless communication system. The method comprises: receiving configuration information for random access channel (RACH) resources; transmitting a first preamble of a random access procedure using a first RACH resource among the RACH resources based on the configuration information; and monitoring a RAR message of the random access procedure based on a first random access radio network temporary identifier (RA-RNTI). The first RA-RNTI is computed based on an index of a time unit of the first RACH resource and an index of the first symbol of the first RACH resource, wherein each time unit consists of 14 symbols in a time domain, and the index of the first symbol of the first RACH resource is a non-negative integer value smaller than 14.

In another aspect of the present invention, provided herein is a user equipment for monitoring a random access response (RAR) in a wireless communication system. The UE comprises: a transceiver, and a processor configured to control the transceiver. The processor is configured to control the transceiver to receive configuration information for random access channel (RACH) resources; control the transceiver to transmit a first preamble of a random access procedure using a first RACH resource among the RACH resources based on the configuration information; and monitor a RAR message of the random access procedure based on a first random access radio network temporary identifier (RA-RNTI). The processor is configured to compute the first RA-RNTI based on an index of a time unit of the first RACH resource and an index of the first symbol of the first RACH resource, wherein each time unit consists of 14 symbols in a time domain, and the index of the first symbol of the first RACH resource is a non-negative integer value smaller than 14.

In a further aspect of the present invention, provided herein is a method for transmitting a random access response (RAR) by a gNB in a wireless communication system. The method comprises: transmitting configuration information for random access channel (RACH) resources; receiving a preamble of a random access procedure using a RACH resource among the RACH resources based on the configuration information; and transmitting a RAR message of the random access procedure based on a random access radio network temporary identifier (RA-RNTI). The RA-RNTI is computed based on an index of a time unit of the RACH resource and an index of the first symbol of the RACH resource, wherein each time unit consists of 14 symbols in a time domain, and the index of the first symbol of the RACH resource is a non-negative integer value smaller than 14.

In a still further aspect of the present invention, provided herein is a base station for transmitting a random access response (RAR) by a gNB in a wireless communication system, the method comprises: a transceiver, and a processor configured to control the transceiver. The processor is configured to: control the transceiver to transmit configuration information for random access channel (RACH) resources; control the transceiver to receive a preamble of a random access procedure using a RACH resource among the RACH resources based on the configuration information; and control the transceiver to transmit a RAR message of the random access procedure based on a random access radio network temporary identifier (RA-RNTI). The processor is configured to compute the RA-RNTI based on an index of a time unit of the RACH resource and an index of the first symbol of the RACH resource, wherein each time unit consists of 14 symbols in a time domain, and the index of the first symbol of the RACH resource is a non-negative integer value smaller than 14.

In each aspect of the present invention, the UE may further transmit a second preamble of the random access procedure using a second RACH resource among the RACH resources based on the configuration information; and monitor a RAR message of the random access procedure based on a second RA-RNTI. The second RACH resource is different from the first RACH resource. The second RA-RNTI may be computed based on an index of a time unit of the second RACH resource and an index of the first symbol of the second RACH resource, wherein the index of the first symbol of the second RACH resource is a non-negative integer value not larger than 14.

In each aspect of the present invention, the gNB may transmit association information between indexes of gNB receiving (Rx) beams and the RACH resources. The UE may receive association information between indexes of gNB receiving (Rx) beams and the RACH resources. The first RA-RNTI may be computed based on an index of a first gNB Rx beam associated with the first RACH resource, the index of the time unit of the first RACH resource, the index of the first symbol of the first RACH resource and a frequency index of the first RACH resource.

The above technical solutions are merely some parts of the embodiments of the present invention and various embodiments into which the technical features of the present invention are incorporated can be derived and understood by persons skilled in the art from the following detailed description of the present invention.

According to the present invention, radio communication signals can be efficiently transmitted/received. Therefore, overall throughput of a radio communication system can be improved.

According to an embodiment of the present invention, delay/latency occurring during communication between a user equipment and a BS may be reduced.

Also, signals in a new radio access technology system can be transmitted/received effectively.

It will be appreciated by persons skilled in the art that the effects that can be achieved through the present invention are not limited to what has been particularly described hereinabove and other advantages of the present invention will be more clearly understood from the following detailed description.

### BRIEF DESCRIPTION OF THE DRAWING

The accompanying drawings, which are included to provide a further understanding of the invention, illustrate embodiments of the invention and together with the description serve to explain the principle of the invention.

FIG. 1 is a view schematically illustrating a network structure of an E-UMTS as an exemplary radio communication system.

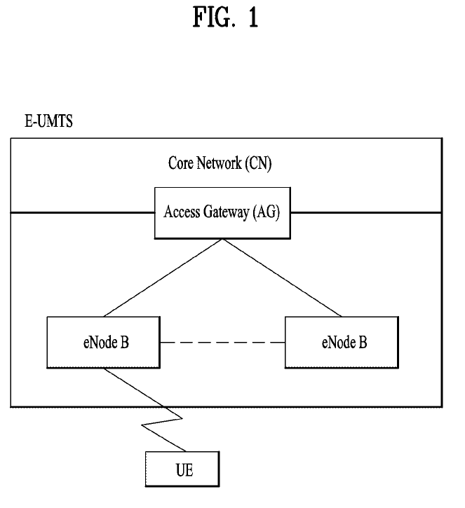

FIG. 2 is a block diagram illustrating network structure of an evolved universal mobile telecommunication system (E-UMTS).

FIG. 3 is a block diagram depicting architecture of a typical E-UTRAN and a typical EPC.

FIG. 4 is a diagram showing a control plane and a user plane of a radio interface protocol between a UE and an E-UTRAN based on a 3GPP radio access network standard.

FIG. 5 is a view showing an example of a physical channel structure used in an E-UMTS system.

FIG. 6 illustrates an example of random access response (RAR) collision between different UEs.

FIG. 7 illustrates examples for a subset of random access channel (RACH) resources.

FIG. 8 illustrates examples of a new field in a random access response message according to an embodiment of the present invention.

FIG. 9 illustrates an RA procedure at UEs according to an embodiment of the present invention.

FIG. 10 illustrates an RA procedure at UEs according to another embodiment of the present invention.

FIG. 11 is a block diagram illustrating elements of a transmitting device 100 and a receiving device 200 for implementing the present invention.

### DETAILED DESCRIPTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. For convenience of description, it is assumed that the present invention is applied to 3GPP based wireless communication system. However, the technical features of the present invention are not limited thereto. For example, although the following detailed description is given based on a mobile communication system corresponding to a 3GPP based system, aspects of the present invention that are not limited to 3GPP based system are applicable to other mobile communication systems.

For example, the present invention is applicable to contention based communication such as Wi-Fi as well as non-contention based communication as in the 3GPP based system in which an eNB allocates a DL/UL time/frequency resource to a UE and the UE receives a DL signal and transmits a UL signal according to resource allocation of the eNB. In a non-contention based communication scheme, an access point (AP) or a control node for controlling the AP allocates a resource for communication between the UE and the AP, whereas, in a contention based communication scheme, a communication resource is occupied through contention between UEs which desire to access the AP. The contention based communication scheme will now be described in brief. One type of the contention based communication scheme is carrier sense multiple access (CSMA). CSMA refers to a probabilistic media access control (MAC) protocol for confirming, before a node or a communication device transmits traffic on a shared transmission medium (also called a shared channel) such as a frequency band, that there is no other traffic on the same shared transmission medium. In CSMA, a transmitting device determines whether another transmission is being performed before attempting to transmit traffic to a receiving device. In other words, the transmitting device attempts to detect presence of a carrier from another transmitting device before attempting to perform transmission. Upon sensing the carrier, the transmitting device waits for another transmission device which is performing transmission to finish transmission, before performing transmission thereof. Consequently, CSMA can be a communication scheme based on the principle of “sense before transmit” or “listen before talk”. A scheme for avoiding collision between transmitting devices in the contention based communication system using CSMA includes carrier sense multiple access with collision detection (CSMA/CD) and/or carrier sense multiple access with collision avoidance (CSMA/CA). CSMA/CD is a collision detection scheme in a wired local area network (LAN) environment. In CSMA/CD, a personal computer (PC) or a server which desires to perform communication in an Ethernet environment first confirms whether communication occurs on a network and, if another device carries data on the network, the PC or the server waits and then transmits data. That is, when two or more users (e.g. PCs, UEs, etc.) simultaneously transmit data, collision occurs between simultaneous transmission and CSMA/CD is a scheme for flexibly transmitting data by monitoring collision. A transmitting device using CSMA/CD adjusts data transmission thereof by sensing data transmission performed by another device using a specific rule. CSMA/CA is a MAC protocol specified in IEEE 802.11 standards. A wireless LAN (WLAN) system conforming to IEEE 802.11 standards does not use CSMA/CD which has been used in IEEE 802.3 standards and uses CA, i.e. a collision avoidance scheme. Transmission devices always sense carrier of a network and, if the network is empty, the transmission devices wait for determined time according to locations thereof registered in a list and then transmit data. Various methods are used to determine priority of the transmission devices in the list and to reconfigure priority. In a system according to some versions of IEEE 802.11 standards, collision may occur and, in this case, a collision sensing procedure is performed. A transmission device using CSMA/CA avoids collision between data transmission thereof and data transmission of another transmission device using a specific rule.

In the present invention, the term “assume” may mean that a subject to transmit a channel transmits the channel in accordance with the corresponding “assumption”. This may also mean that a subject to receive the channel receives or decodes the channel in a form conforming to the “assumption”,” on the assumption that the channel has been transmitted according to the “assumption”.

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. Especially, a BS of the UMTS is often referred to as a NB, a BS of the EPC/LTE is often referred to as an eNB, and a BS of the new radio (NR) system is often referred to as a gNB.

In the present invention, a node refers to a fixed point capable of transmitting/receiving a radio signal through communication with a UE. Various types of eNBs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be an eNB. For example, the node may be a radio remote head (RRH) or a radio remote unit (RRU). The RRH or RRU generally has a lower power level than a power level of an eNB. Since the RRH or RRU (hereinafter, RRH/RRU) is generally connected to the eNB through a dedicated line such as an optical cable, cooperative communication between RRH/RRU and the eNB can be smoothly performed in comparison with cooperative communication between eNBs connected by a radio line. At least one antenna is installed per node. The antenna may mean a physical antenna or mean an antenna port or a virtual antenna.

In the present invention, a cell refers to a prescribed geographical area to which one or more nodes provide a communication service. Accordingly, in the present invention, communicating with a specific cell may mean communicating with an eNB or a node which provides a communication service to the specific cell. In addition, a DL/UL signal of a specific cell refers to a DL/UL signal from/to an eNB or a node which provides a communication service to the specific cell. A node providing UL/DL communication services to a UE is called a serving node and a cell to which UL/DL communication services are provided by the serving node is especially called a serving cell.

Meanwhile, a 3GPP based system uses the concept of a cell in order to manage radio resources and a cell associated with the radio resources is distinguished from a cell of a geographic region.

A “cell” of a geographic region may be understood as coverage within which a node can provide service using a carrier and a “cell” of a radio resource is associated with bandwidth (BW) which is a frequency range configured by the carrier. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of a radio resource used by the node. Accordingly, the term “cell” may be used to indicate service coverage of the node sometimes, a radio resource at other times, or a range that a signal using a radio resource can reach with valid strength at other times.

Meanwhile, the recent 3GPP based wireless communication standard uses the concept of a cell to manage radio resources. The “cell” associated with the radio resources is defined by combination of downlink resources and uplink resources, that is, combination of DL component carrier (CC) and UL CC. The cell may be configured by downlink resources only, or may be configured by downlink resources and uplink resources. If carrier aggregation is supported, linkage between a carrier frequency of the downlink resources (or DL CC) and a carrier frequency of the uplink resources (or UL CC) may be indicated by system information. For example, combination of the DL resources and the UL resources may be indicated by linkage of system information block type 2 (SIB2). In this case, the carrier frequency means a center frequency of each cell or CC. A cell operating on a primary frequency may be referred to as a primary cell (Pcell) or PCC, and a cell operating on a secondary frequency may be referred to as a secondary cell (Scell) or SCC. The carrier corresponding to the Pcell on downlink will be referred to as a downlink primary CC (DL PCC), and the carrier corresponding to the Pcell on uplink will be referred to as an uplink primary CC (UL PCC). A Scell means a cell that may be configured after completion of radio resource control (RRC) connection establishment and used to provide additional radio resources. The Scell may form a set of serving cells for the UE together with the Pcell in accordance with capabilities of the UE. The carrier corresponding to the Scell on the downlink will be referred to as downlink secondary CC (DL SCC), and the carrier corresponding to the Scell on the uplink will be referred to as uplink secondary CC (UL SCC). Although the UE is in RRC-CONNECTED state, if it is not configured by carrier aggregation or does not support carrier aggregation, a single serving cell configured by the Pcell only exists.

In the present invention, “PDCCH” refers to a PDCCH, an EPDCCH (in subframes when configured), a MTC PDCCH (MPDCCH), for an RN with R-PDCCH configured and not suspended, to the R-PDCCH or, for NB-IoT to the narrowband PDCCH (NPDCCH).

In the present invention, monitoring a channel implies attempting to decode the channel. For example, monitoring a PDCCH implies attempting to decode PDCCH(s) (or PDCCH candidates).

In the present invention, for dual connectivity operation the term “special Cell” refers to the PCell of the master cell group (MCG) or the PSCell of the secondary cell group (SCG), otherwise the term Special Cell refers to the PCell. The MCG is a group of serving cells associated with a master eNB (MeNB) which terminates at least S1-MME, and the SCG is a group of serving cells associated with a secondary eNB (SeNB) that is providing additional radio resources for the UE but is not the MeNB. The SCG is comprised of a primary SCell (PSCell) and optionally one or more SCells. In dual connectivity, two MAC entities are configured in the UE: one for the MCG and one for the SCG. Each MAC entity is configured by RRC with a serving cell supporting PUCCH transmission and contention based Random Access. In this specification, the term SpCell refers to such cell, whereas the term SCell refers to other serving cells. The term SpCell either refers to the PCell of the MCG or the PSCell of the SCG depending on if the MAC entity is associated to the MCG or the SCG, respectively.

In the present invention, “C-RNTI” refers to a cell RNTI, “SI-RNTI” refers to a system information RNTI, “P-RNTI” refers to a paging RNTI, “RA-RNTI” refers to a random access RNTI, “SC-RNTI” refers to a single cell RNTI″, “SL-RNTI” refers to a sidelink RNTI, and “SPS C-RNTI” refers to a semi-persistent scheduling C-RNTI.

For terms and technologies which are not specifically described among the terms of and technologies employed in this specification, 3GPP LTE/LTE-A standard documents, for example, 3GPP TS 36.211, 3GPP TS 36.212, 3GPP TS 36.213, 3GPP TS 36.300, 3GPP TS 36.321, 3GPP TS 36.322, 3GPP TS 36.323 and 3GPP TS 36.331, and 3GPP NR standard documents, for example, 3GPP TS 38.211, 3GPP TS 38.213, 3GPP TS 38.214, 3GPP TS 38.300, 3GPP TS 38.321, 3GPP TS 38.322, 3GPP TS 38.323 and 3GPP TS 38.331 may be referenced.

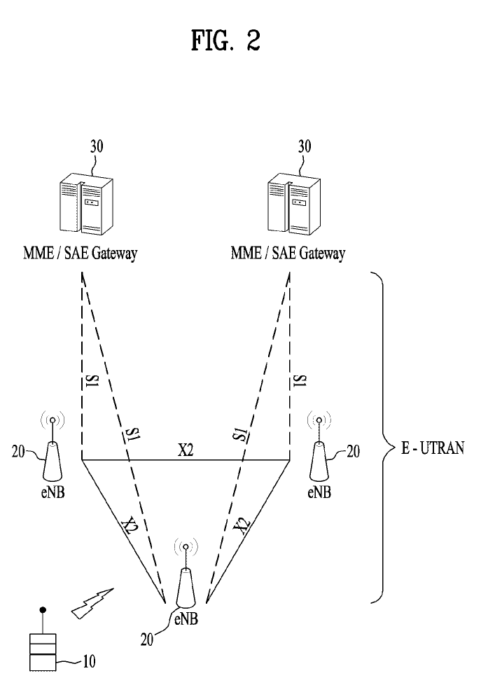

FIG. 2 is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNB 20 to UE 10, and “uplink” refers to communication from the UE to an eNB.

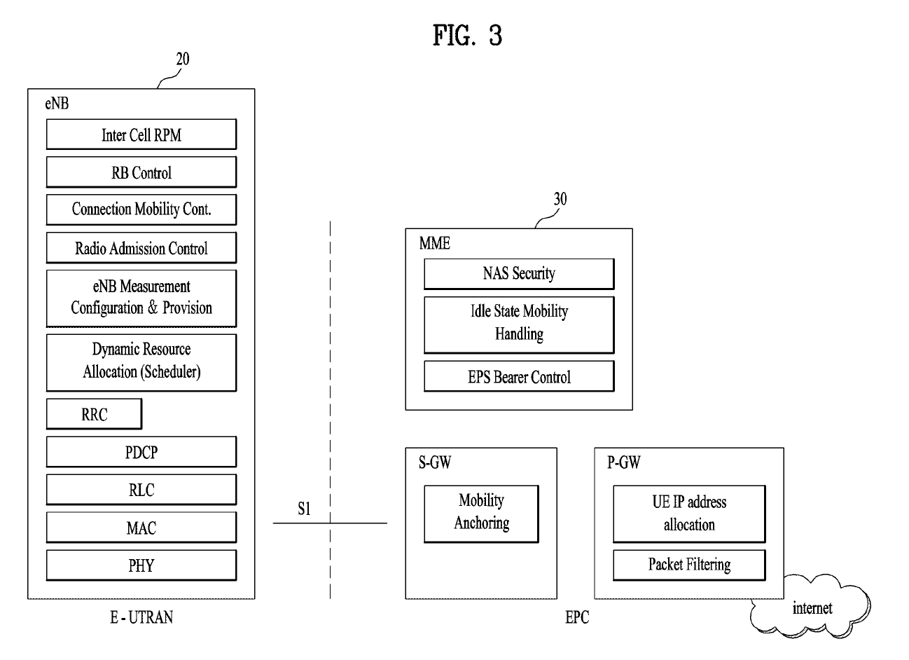

FIG. 3 is a block diagram depicting architecture of a typical E-UTRAN and a typical EPC.

As illustrated in FIG. 3, an eNB 20 provides end points of a user plane and a control plane to the UE 10. MME/SAE gateway 30 provides an end point of a session and mobility management function for UE 10. The eNB and MME/SAE gateway may be connected via an S1 interface.

The eNB 20 is generally a fixed station that communicates with a UE 10, and may also be referred to as a base station (BS) or an access point. One eNB 20 may be deployed per cell. An interface for transmitting user traffic or control traffic may be used between eNBs 20.

The MME provides various functions including NAS signaling to eNBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, roaming, authentication, bearer management functions including dedicated bearer establishment, support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNB 20 and gateway 30 via the S1 interface. The eNBs 20 may be connected to each other via an X2 interface and neighboring eNBs may have a meshed network structure that has the X2 interface.

As illustrated, eNB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNB measurements, radio bearer control, radio admission control (RAC), and connection mobility control in LTE_ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

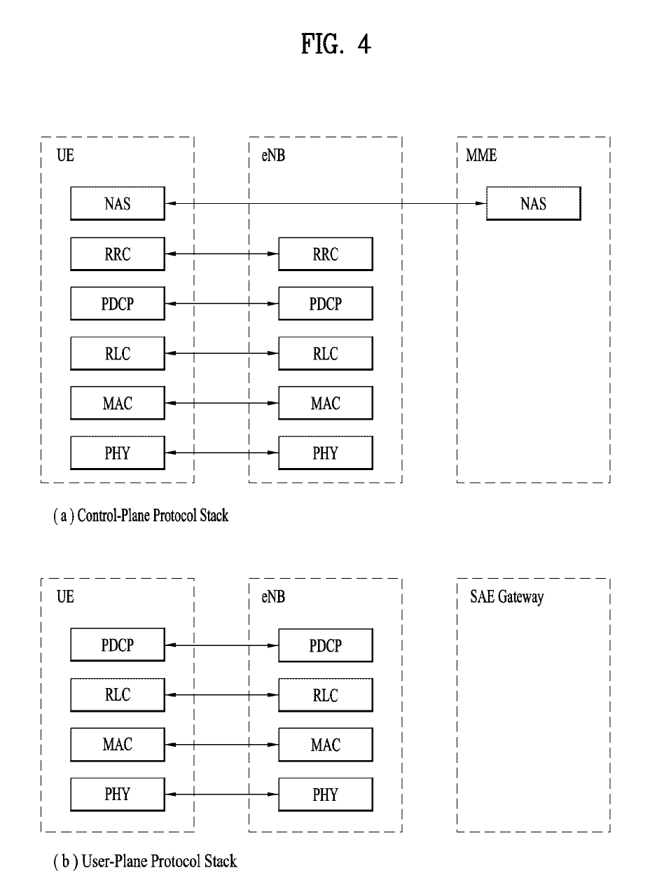

FIG. 4 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

Layer 1 (i.e. L1) of the 3GPP LTE/LTE-A system is corresponding to a physical layer. A physical (PHY) layer of a first layer (Layer 1 or L1) provides an information transfer service to a higher layer using a physical channel. The PHY layer is connected to a medium access control (MAC) layer located on the higher layer via a transport channel Data is transported between the MAC layer and the PHY layer via the transport channel Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

Layer 2 (i.e. L2) of the 3GPP LTE/LTE-A system is split into the following sublayers: Medium Access Control (MAC), Radio Link Control (RLC) and Packet Data Convergence Protocol (PDCP). The MAC layer of a second layer (Layer 2 or L2) provides a service to a radio link control (RLC) layer of a higher layer via a logical channel The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

The main services and functions of the MAC sublayer include: mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ; priority handling between logical channels of one UE; priority handling between UEs by means of dynamic scheduling; MBMS service identification; transport format selection; and padding.

The main services and functions of the RLC sublayer include: transfer of upper layer protocol data units (PDUs); error correction through ARQ (only for acknowledged mode (AM) data transfer); concatenation, segmentation and reassembly of RLC service data units (SDUs) (only for unacknowledged mode (UM) and acknowledged mode (AM) data transfer); re-segmentation of RLC data PDUs (only for AM data transfer); reordering of RLC data PDUs (only for UM and AM data transfer); duplicate detection (only for UM and AM data transfer); protocol error detection (only for AM data transfer); RLC SDU discard (only for UM and AM data transfer); and RLC re-establishment, except for a NB-IoT UE that only uses Control Plane CIoT EPS optimizations. Radio Bearers are not characterized by a fixed sized data unit (e.g. a fixed sized RLC PDU).

The main services and functions of the PDCP sublayer for the user plane include: header compression and decompression: ROHC only; transfer of user data; in-sequence delivery of upper layer PDUs at PDCP re-establishment procedure for RLC AM; for split bearers in DC and LWA bearers (only support for RLC AM): PDCP PDU routing for transmission and PDCP PDU reordering for reception; duplicate detection of lower layer SDUs at PDCP re-establishment procedure for RLC AM; retransmission of PDCP SDUs at handover and, for split bearers in DC and LWA bearers, of PDCP PDUs at PDCP data-recovery procedure, for RLC AM; ciphering and deciphering; timer-based SDU discard in uplink. The main services and functions of the PDCP for the control plane include: ciphering and integrity protection; and transfer of control plane data. For split and LWA bearers, PDCP supports routing and reordering. For DRBs mapped on RLC AM and for LWA bearers, the PDCP entity uses the reordering function when the PDCP entity is associated with two AM RLC entities, when the PDCP entity is configured for a LWA bearer; or when the PDCP entity is associated with one AM RLC entity after it was, according to the most recent reconfiguration, associated with two AM RLC entities or configured for a LWA bearer without performing PDCP re-establishment.

Layer 3 (i.e. L3) of the LTE/LTE-A system includes the following sublayers: Radio Resource Control (RRC) and Non Access Stratum (NAS). A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other. The non-access stratum (NAS) layer positioned over the RRC layer performs functions such as session management and mobility management.

Radio bearers are roughly classified into (user) data radio bearers (DRBs) and signaling radio bearers (SRBs). SRBs are defined as radio bearers (RBs) that are used only for the transmission of RRC and NAS messages.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

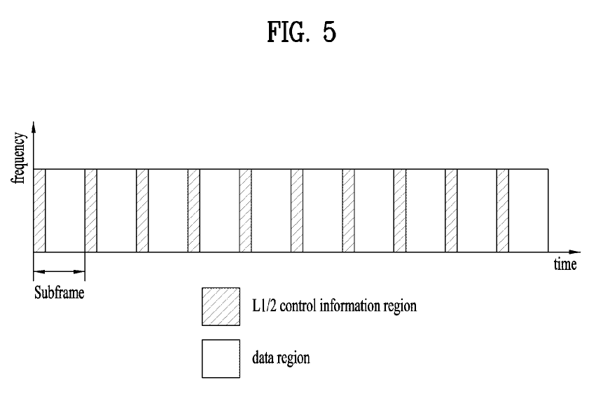

FIG. 5 is a view showing an example of a physical channel structure used in an E-UMTS system. A physical channel includes several subframes on a time axis and several subcarriers on a frequency axis. Here, one subframe includes a plurality of symbols on the time axis. One subframe includes a plurality of resource blocks and one resource block includes a plurality of symbols and a plurality of subcarriers. In addition, each subframe may use certain subcarriers of certain symbols (e.g., a first symbol) of a subframe for a physical downlink control channel (PDCCH), that is, an L1/L2 control channel. The PDCCH carries scheduling assignments and other control information. In FIG. 5, an L1/L2 control information transmission area (PDCCH) and a data area (PDSCH) are shown. In one embodiment, a radio frame of 10 ms is used and one radio frame includes 10 subframes. In addition, one subframe includes two consecutive slots. The length of one slot may be 0.5 ms. In addition, one subframe includes a plurality of OFDM symbols and a portion (e.g., a first symbol) of the plurality of OFDM symbols may be used for transmitting the L1/L2 control information.

A time interval in which one subframe is transmitted is defined as a transmission time interval (TTI). Time resources may be distinguished by a radio frame number (or radio frame index), a subframe number (or subframe index), a slot number (or slot index), and the like. TTI refers to an interval during which data may be scheduled. For example, in the 3GPP LTE/LTE-A system, an opportunity of transmission of an UL grant or a DL grant is present every 1 ms, and the UL/DL grant opportunity does not exists several times in less than 1 ms. Therefore, the TTI in the legacy 3GPP LTE/LTE-A system is 1 ms.

A base station and a UE mostly transmit/receive data via a PDSCH, which is a physical channel, using a DL-SCH which is a transmission channel, except a certain control signal or certain service data. Information indicating to which UE (one or a plurality of UEs) PDSCH data is transmitted and how the UE receive and decode PDSCH data is transmitted in a state of being included in the PDCCH.

For example, in one embodiment, a certain PDCCH is CRC-masked with a radio network temporary identity (RNTI) “A” and information about data is transmitted using a radio resource “B” (e.g., a frequency location) and transmission format information “C” (e.g., a transmission block size, modulation, coding information or the like) via a certain subframe. Then, one or more UEs located in a cell monitor the PDCCH using its RNTI information. And, a specific UE with RNTI “A” reads the PDCCH and then receive the PDSCH indicated by B and C in the PDCCH information. In the present invention, a PDCCH addressed to a certain RNTI means that the PDCCH is CRC-masked with the certain RNTI. A UE may attempt to decode a PDCCH using the certain RNTI if the UE is monitoring a PDCCH addressed to the certain RNTI.

If a UE is powered on or newly enters a cell, the UE performs an initial cell search procedure of acquiring time and frequency synchronization with the cell and detecting a physical cell identity N^{cell}_{ID} of the cell. To this end, the UE may establish synchronization with the eNB by receiving synchronization signals, e.g. a primary synchronization signal (PSS) and a secondary synchronization signal (SSS), from the eNB and obtain information such as a cell identity (ID). The UE having finished initial cell search may perform the random access procedure to complete access to the eNB. To this end, the UE may transmit a preamble through a physical random access channel (PRACH), and receive a response message which is a response to the preamble through a PDCCH and PDSCH. In the case of contention-based random access, transmission of an additional PRACH and a contention resolution procedure for the PDCCH and a PDSCH corresponding to the PDCCH may be performed. After performing the procedure described above, the UE may perform PDCCH/PDSCH reception and PUSCH/PUCCH transmission as a typical procedure of transmission of an uplink/downlink signal.

The random access procedure is also referred to as a random access channel (RACH) procedure. The random access procedure is common procedure for FDD and TDD, and one procedure irrespective of cell size and the number of serving cells when carrier aggregation (CA) is configured. The random access procedure is used for various purposes including initial access, adjustment of uplink synchronization, resource assignment, and handover. Random access procedures are classified into a contention-based procedure and a dedicated (i.e., non-contention-based) procedure. The contention-based random access procedure is used for general operations including initial access, while the dedicated random access procedure is used for limited operations such as handover. In the contention-based random access procedure, the UE randomly selects a RACH preamble sequence. Accordingly, it is possible that multiple UEs transmit the same RACH preamble sequence at the same time. Thereby, a contention resolution procedure needs to be subsequently performed. On the other hand, in the dedicated random access procedure, the UE uses an RACH preamble sequence that the eNB uniquely allocates to the UE. Accordingly, the random access procedure may be performed without contention with other UEs.

The contention-based random access procedure includes the following four steps. Messages/transmissions in Steps 1 to 4 given below may be referred to as Msg1 to Msg4, respectively.
1) Step 1: Random Access Preamble on RACH in uplink (Msg1 from UE to BS):
2) Step 2: Random Access Response generated by MAC on DL-SCH (Msg2 from BS to UE):
3) Step 3: First scheduled UL transmission on UL-SCH (Msg3 from UE to BS):
4) Step 4: Contention Resolution on DL (Msg4 from BS to UE):

Once the Random Access Preamble is transmitted and regardless of the possible occurrence of a measurement gap or a Sidelink Discovery Gap for Transmission or a Sidelink Discovery Gap for Reception, the MAC entity monitors the PDCCH of the SpCell for Random Access Response(s) identified by the RA-RNTI defined below, in the Random Access Response (RAR) window which starts at the subframe that contains the end of the preamble transmission plus three subframes and has length ra-ResponseWindowSize. The parameter ra-ResponseWindowSize is configured by a BS through system information or mobility control information. If the UE is a BL UE or a UE in enhanced coverage, RAR window starts at the subframe that contains the end of the last preamble repetition plus three subframes and has length ra-ResponseWindowSize for the corresponding coverage level. If the UE is an NB-IoT UE, in case the number of NPRACH repetitions is greater than or equal to 64, RAR starts at the subframe that contains the end of the last preamble repetition plus 41 subframes and has length ra-ResponseWindowSize for the corresponding coverage level, and in case the number of NPRACH repetitions is less than 64, RAR window starts at the subframe that contains the end of the last preamble repetition plus 4 subframes and has length ra-ResponseWindowSize for the corresponding coverage level. The RA-RNTI associated with the PRACH in which the Random Access Preamble is transmitted, is computed as RA-RNTI=1+t_id+10*f_id, where t_id is the index of the first subframe of the specified PRACH (0≤t_id<10), and f_id is the index of the specified PRACH within that subframe, in ascending order of frequency domain (0≤f_id<6) except for NB-IoT UEs, BL UEs or UEs in enhanced coverage. If the PRACH resource is on a TDD carrier, the f_id is set to f_{RA}, where f_{RA} is a PRACH resource frequency index within the considered time-domain location as defined in Section 5.7.1 of 3GPP TS 36.211. For BL UEs and UEs in enhanced coverage, RA-RNTI associated with the PRACH in which the Random Access Preamble is transmitted, is computed as RA-RNTI=1+t_id+10*f_id+60*(SFN_id mod (Wmax/10)), where t_id is the index of the first subframe of the specified PRACH (0≤t_id<10), f_id is the index of the specified PRACH within that subframe, in ascending order of frequency domain (0≤f_id<6), SFN_id is the index of the first radio frame of the specified PRACH, and Wmax is 400, maximum possible RAR window size in subframes for BL UEs or UEs in enhanced coverage. If the PRACH resource is on a TDD carrier, the f_id is set to f_{RA}, where f_{RA} is a PRACH resource frequency index within the considered time-domain location as defined in Section 5.7.1 of 3GPP TS 36.211. For NB-IoT UEs, the RA-RNTI associated with the PRACH in which the Random Access Preamble is transmitted, is computed as RA-RNTI=1+floor(SFN_id/4)+256*carrier_id, where SFN_id is the index of the first radio frame of the specified PRACH and carrier_id is the index of the UL carrier associated with the specified PRACH. The carrier_id of the anchor carrier is 0.

In detecting the RA-RNTI PDCCH, the UE checks the PDSCH for presence of an RAR directed thereto. The RAR includes timing advance (TA) information indicating timing offset information for UL synchronization, UL resource allocation information (UL grant information), and a random UE identifier (e.g., temporary cell-RNTI (TC-RNTI)). The PDSCH corresponding to the RA-RNTI PDCCH carries one DL-SCH message intended for a variable number of UEs. The MAC entity may stop monitoring for Random Access Response(s) after successful reception of a Random Access Response containing Random Access Preamble identifiers that matches the transmitted Random Access Preamble. The UE may perform UL transmission (i.e., Msg3) according to the resource allocation information and the TA value in the RAR. HARQ is applied to UL transmission corresponding to the RAR. Accordingly, after transmitting Msg3, the UE may receive acknowledgement information (e.g., PHICH) corresponding to Msg3.

A fully mobile and connected society is expected in the near future, which will be characterized by a tremendous amount of growth in connectivity, traffic volume and a much broader range of usage scenarios. Some typical trends include explosive growth of data traffic, great increase of connected devices and continuous emergence of new services. Besides the market requirements, the mobile communication society itself also requires a sustainable development of the eco-system, which produces the needs to further improve system efficiencies, such as spectrum efficiency, energy efficiency, operational efficiency and cost efficiency. To meet the above ever-increasing requirements from market and mobile communication society, next generation access technologies are expected to emerge in the near future.

Building upon its success of IMT-2000 (3G) and IMT-Advanced (4G), 3GPP has been devoting its effort to IMT-2020 (5G) development since September 2015. 5G New Radio (NR) is expected to expand and support diverse use case scenarios and applications that will continue beyond the current IMT-Advanced standard, for instance, enhanced Mobile Broadband (eMBB), Ultra Reliable Low Latency Communication (URLLC) and massive Machine Type Communication (mMTC). eMBB is targeting high data rate mobile broadband services, such as seamless data access both indoors and outdoors, and AR/VR applications; URLLC is defined for applications that have stringent latency and reliability requirements, such as vehicular communications that can enable autonomous driving and control network in industrial plants; mMTC is the basis for connectivity in IoT, which allows for infrastructure management, environmental monitoring, and healthcare applications.

RAN WG1 at 3GPP has been approaching the physical layer design with eMBB services and verticals in mind. Wide bandwidth (e.g. 100 MHz below 6 GHz and up to 400 MHz for Millimeter Wave [high priority: 24.25 GHz-29.5 GHz]) is the basic method for achieving ultra-high data rates. Many other techniques, such as carrier aggregation, multiple or massive antenna, and low-density parity-check (LDPC) coding, are also considered for data rate boosting (up to 20 Gbps). In a high-mobility scenario (e.g. high-speed train (HST) with velocity up to 500 km/h), a higher density of reference symbols (RS) would be flexibly configured for robustness against a faster time-varying channel In terms of low latency, a smaller periodicity of the slot is preferred, and self-contained slot structure is agreed due to its fast ACK/NACK for data transmissions. Additionally, 5G NR hopes to support URLLC services and eMBB services simultaneously on one carrier. URLLC is implemented with a higher priority with guaranteed time-frequency resource by puncturing the eMBB services. To summarize, flexible design and configuration of the transmission modes and parameters are the core idea of 5G NR.

In a millimeter wave band, the wavelength is short, and thus a plurality of antenna elements may be installed in the same area. For example, a total of 100 antenna elements may be installed in a 5-by-5 cm panel in a 30 GHz band with a wavelength of about 1 cm in a 2-dimensional array at intervals of 0.5λ (wavelength). Therefore, in mmW, increasing the coverage or the throughput by increasing the beamforming (BF) gain using multiple antenna elements is taken into consideration. If a transceiver unit (TXRU) is provided for each antenna element to enable adjustment of transmit power and phase, independent beamforming is possible for each frequency resource. However, installing TXRU in all of the about 100 antenna elements is less feasible in terms of cost. Therefore, a method of mapping a plurality of antenna elements to one TXRU and adjusting the direction of a beam using an analog phase shifter is considered. This analog beamforming method may only make one beam direction in the whole band, and thus may not perform frequency selective beamforming (BF), which is disadvantageous. Hybrid BF with B TXRUs that are fewer than Q antenna elements as an intermediate form of digital BF and analog BF may be considered. In the case of hybrid BF, the number of directions in which beams may be transmitted at the same time is limited to B or less, which depends on the method of collection of B TXRUs and Q antenna elements.

A gNB and a UE should determine a spatial direction (i.e. beam) in order to communicate with each other. In other words, a gNB and a UE should select appropriate Rx beam(s) out of beam candidates. In order to facilitate this procedure, the NR system specifies time slots that will be used by a gNB to sweep Tx beams with transmissions of synchronization signal (SS) blocks. In each SS block, a transmission over one gNB Tx beam direction consists of PSS, SSS and PBCH that need to be obtained before exchange of initial access information. In other slots used to detect random access preambles, a gNB tunes its Rx antennas to sweep gNB Rx beams. A UE receives the primary synchronization signal (PSS) and secondary synchronization signal (SSS) in order to acquire time and frequency synchronization with a cell and detect the physical layer Cell ID of that cell. A UE assumes that reception occasions of PBCH, PSS, and SSS are in consecutive symbols and form a SS block. The periodicity of the SS block can be configured by the network and the time locations where SS block can be sent are determined by subcarrier spacing. SS blocks that a gNB actually transmits in a cell can be informed to UE(s) via system information or RRC configuration information.

One or multiple SS block(s) compose an SS burst. One or multiple SS burst(s) further compose an SS burst set where the number of SS bursts within a SS burst set is finite. From a physical layer perspective, at least one periodicity of SS burst set is supported. From a UE perspective, SS burst set transmission is periodic and UE may assume that a given SS block is repeated with a SS burst set periodicity. PBCH contents in a given repeated SS block may change. A single set of possible SS block time locations is specified per frequency band. The maximum number of SS-blocks within SS burst set may be carrier frequency dependent. The position(s) of actual transmitted SS blocks can be informed for helping CONNECTED/IDLE mode measurement, for helping a CONNECTED mode UE to receive DL data/control in unused SS blocks and potentially for helping an IDLE mode UE to receive DL data/control in unused SS blocks. At least for multi-beams case, at least the time index of SS block is indicated to the UE. For CONNECTED and IDLE mode UEs, NR supports network indication of SS burst set periodicity and information to derive measurement timing/duration (e.g., time window for SS block detection). The network provides one SS burst set periodicity information per frequency carrier to UE and information to derive measurement timing/duration if possible. If the network does not provide indication of SS burst set periodicity and information to derive measurement timing/duration the UE should assume 5 ms as the SS burst set periodicity.

The RACH procedure including RACH preamble (Msg1), random access response (Msg2), Msg3, and Msg4 is assumed for NR from physical layer perspective. The RACH procedure, i.e., random access procedure is supported for both IDLE mode and CONNECTED mode UEs. For 4-step RACH procedure, a RACH transmission occasion is defined as the time-frequency resource on which a PRACH Msg1 is transmitted using the configured PRACH preamble format with a single particular UE Tx beam. A RACH resource is also defined as a time-frequency resource that a UE can send a RACH preamble. Whether a UE needs to transmit one or multiple/repeated preambles within a subset of RACH resources can be informed by broadcast system information, e.g., to cover gNB Rx beam sweeping in case of no Tx/Rx beam correspondence at the gNB.

In NR, the followings are defined as Tx/Rx beam correspondence at a transmission and reception point (TRP) and UE. Tx/Rx beam correspondence at a TRP (e.g. gNB) holds if the TRP is able to determine a TRP Rx beam for the uplink reception based on UE's downlink measurement on TRP's one or more Tx beams, and/or if the TRP is able to determine a TRP Tx beam for the downlink transmission based on TRP's uplink measurement on TRP's one or more Rx beams. Tx/Rx beam correspondence at a UE holds if the UE is able to determine a UE Tx beam for the uplink transmission based on UE's downlink measurement on UE's one or more Rx beams, if the UE is able to determine a UE Rx beam for the downlink reception based on TRP's indication based on uplink measurement on UE's one or more Tx beams, and/or if capability indication of UE beam correspondence related information to a TRP is supported.

Regardless of whether Tx/Rx beam correspondence is available or not at a gNB at least for multiple beams operation, the following RACH procedure is considered for at least UE(s) in IDLE mode. Association between one or multiple occasions for DL broadcast channel/signal (e.g. SS block) and a subset of RACH resources is informed to a UE by broadcast system information or known to the UE. Based on the DL measurement and the corresponding association, a UE selects the subset of RACH preamble indices. UE Tx beam(s) for preamble transmission(s) is selected by the UE. At least for the case without gNB Tx/Rx beam correspondence, a gNB can configure an association between DL signal/channel (e.g. SS block), and a subset of RACH resources and/or a subset of preamble indices, for determining Msg2 DL Tx beam. Based on the DL measurement and the corresponding association, UE selects the subset of RACH resources and/or the subset of RACH preamble indices. A preamble index consists of preamble sequence index and orthogonal cover code (OCC) index, if OCC is supported. Regardless of whether Tx/Rx beam correspondence is available or not at a gNB at least for multiple beams operation, the DL Tx beam (i.e. gNB Tx beam) for Msg2 can be obtained at the gNB based on the detected RACH preamble/resource and the corresponding association. UL grant in Msg2 may indicate the transmission timing of Msg3. Basically a UE assumes single RAR reception within a given RAR window. At least for a UE in IDLE mode, a UL Tx beam (i.e., UE Tx beam) for Msg3 transmission may be determined by the UE.

In NR, a gNB can form multiple gNB Tx beams with transmissions of SS blocks on a cell, i.e, perform DL beam sweeping for transmission of SS block. During initial access, a UE can detect multiple beams by monitoring SS blocks and UE selects a suitable/best gNB Tx beam based on the DL measurement. If the gNB Tx/Rx beam correspondence is available, the UE can figure out both the gNB and Rx beams based on the DL measurement. Therefore, the gNB Tx/Rx beam correspondence is available, the UE can use both the gNB Tx and Rx beams, during random access procedure, based on the DL measurement and corresponding association. In this case, one preamble transmission for a single gNB Rx beam may be sufficient to successfully perform the RA procedure.

However, if a UE transmits one preamble for a specific gNB Rx beam within a single RA procedure when gNB Tx/Rx reciprocity (i.e. gNB Tx/Rx beam correspondence) is not available, it may increase the latency to initial access because the UE does not know its suitable gNB Rx beams. Accordingly, for the performance of RA procedure, it would be preferable that a UE transmits the multiple/repeated preambles for the full/partial of gNB Rx beams within a single RA procedure in case gNB Tx/Rx correspondence is not available.

Unlike LTE, NR supports multiple numerologies (e.g. multiple subcarrier spacings) and the region for PRACH transmission could be aligned to the boundary of uplink symbol, slot or subframe. For NR RA procedure, how to compute the RA-RNTI for the transmitted RACH preambles should be because the time unit of a PRACH resource could be different from LTE. However, regardless of the RA-RNTI, it should be first discussed whether the MAC layer needs to transmit the multiple/repeated preambles for the full/partial gNB Rx beams.

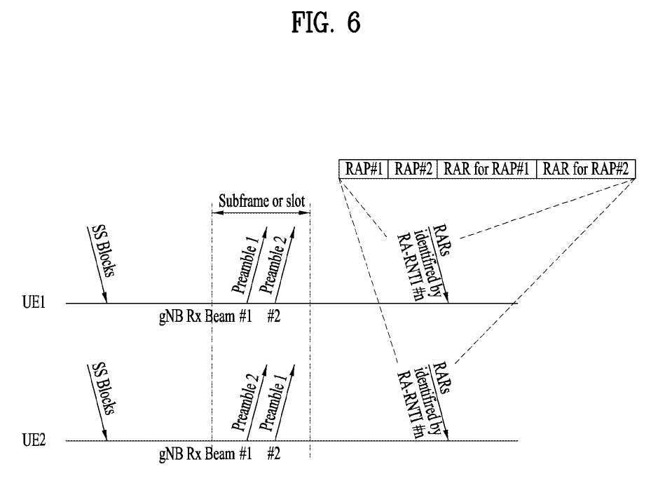

FIG. 6 illustrates an example of RAR collision between different UEs.

If preamble repetition for gNB Rx beam sweeping is supported by PHY layer, it would not be necessary to consider the multiple/repeated preambles for the full/partial gNB Rx beams in MAC layer. Although the Tx/Rx beam correspondence is not available at a gNB, the preamble repetition for the full/partial gNB Rx beams also can be designed to follow the decision of PHY layer. Based on the design, the gNB can select the best gNB Rx beam of a UE by considering that the repeated preambles are transmitted from one UE. In this case, a UE can receive a single RAR including a UL grant for the best gNB Rx beam. However, if a UE transmits multiple/different preambles for multiple gNB Rx beams within a single RA procedure, it can give rise to the RAR collision between UEs as shown in FIG. 6.

A UE cannot exactly detect its RAR message although the gNB successfully receives the preamble of the UE for a specific gNB Rx beam without preamble collision between different UEs. For example, during initial access, two UEs could select the same gNB Tx beam based on DL measurement, and transmit randomly selected multiple/different preambles on a subset of PRACH resources informed by the gNB. In this case, UEs do not need to know detailed information of gNB Rx beams. According to the current RA procedure, it leads to RAR collision because it is not possible to distinguish RAR message between different gNB Rx beams, even if the gNB can successfully detect each preamble for the gNB Rx beams. For example, referring to FIG. 6, if UE1 detects or selects a SS block (i.e. gNB Tx beam) on a cell and transmits preamble 1 (RAP#1) on a RACH resource (RO#1) associated with the SS block and preamble 2 (RAP#2) on another RACH resource (RO#2) associated with the SS block, and if the UE2 detects or selects the same SS block as that of the UE1 and transmits preamble 2 (RAP#2) on the RACH resource (RO#1) associated with the SS block and preamble 1 (RAP#1) on the RACH resource (RO#2) associated with the SS block, it is unclear whether RAP#1 in a RAR message is corresponding to RAP#1 transmitted by UE1 or RAP#1 transmitted by UE2. If the RA-RNTI associated with the PRACH is computed as RA-RNTI=1+t_id+10*f_id in the same manner as LTE, RARs of UE1 and UE2 cannot be distinguished by the RA-RNTI.

Accordingly, in order to support multiple/different preambles within a single RA procedure, a new scheme should be defined in MAC layer. For convenience of description, the present invention is described mainly assuming that the region for PRACH transmission is aligned to a subframe. However, the present invention can be also applied in the same or similar manner even if a PRACH transmission of NR is aligned to uplink (data) symbol or uplink slot with the same numerology (e.g. subcarrier spacing).

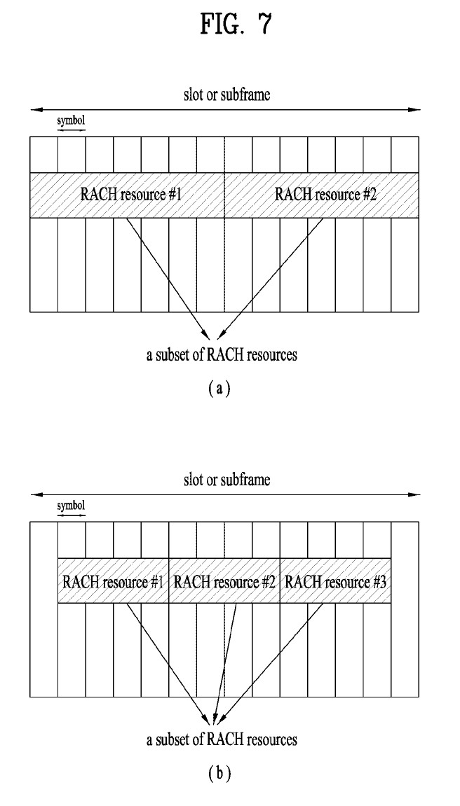

FIG. 7 illustrates examples for a subset of RACH resources.

The present invention proposes a scheme for distinguishing different preambles transmitted on a subset of PRACH resources in case that a UE transmits multiple preambles within a single random access procedure. In particular, the present invention can be applied to multiple/different preambles for a full/partial gNB Rx beams which is transmitted within a subset of PRACH resources. In the present invention, it is assumed that the subset of PRACH resources is aligned to the boundary of uplink symbol, slot or subframe and the subset of PRACH resources can be composed of n PRACH resources as shown in FIG. 7, where n is a positive integer. The preamble sequence which is transmitted on a PRACH resource follows the PRACH format indicated by a gNB. Information of PRACH configuration can be transmitted in the system information by a gNB. Similar to LTE, the information of PRACH configuration may provide UE(s) with information about a radio frame having RACH resources, a subframe/slot having RACH resources and a RACH preamble format.

The present invention first defines the index indicating the multiple PRACH resources/gNB Rx beams which can be allocated in a specific time unit. The proposed index can be explicitly transmitted in the system information with the PRACH configuration or it can be implicitly mapped to the physical or logical index of the PRACH resource. Then, a UE can know the value for each PRACH resource/gNB Rx beam within a subset of RACH resources by an explicit/implicit signaling. The detailed value of the proposed index can be set to one of followings.
Physical/logical index of gNB Rx beam. It can be transmitted by gNB. It can be transmitted in the system information including the PRACH configuration.
Logical index in a time unit for a subset of PRACH resources. UE can compute the logical index from the number of PRACH resources within a subset of RACH resources.
The first/last symbol/slot index of a PRACH resource. UE can get the physical index (i.e., the first or last symbol index of a PRACH resource, or the first or last slot index of a PRACH resource) from system information including the RACH configuration.

Scheme 1. Definition of a New Field in RAR Message

The scheme 1 is applied to the case that the RAR for multiple/different preambles, which is transmitted on the different PRACH resources/gNB Rx beams, is addressed to a single/same RA-RNTI.

In order to help a UE differentiate the duplicated preamble indices for different PRACH resources/gNB Rx beams, the present invention proposes to define a new filed for the proposed index in the RAR message. The proposed index can be set to one of the above mentioned values. The new filed for the proposed index can be defined in the MAC sub-header for RAR or in the MAC RAR message.

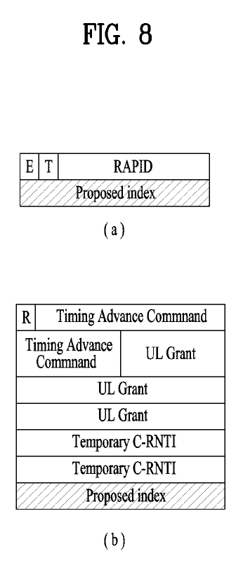

FIG. 8 illustrates examples of a new field in a random access response message according to an embodiment of the present invention. Especially, FIG. 8(a) illustrates an example of MAC sub-header including the proposed index, and FIG. 8(b) illustrates an example of MAC RAR including the proposed index.

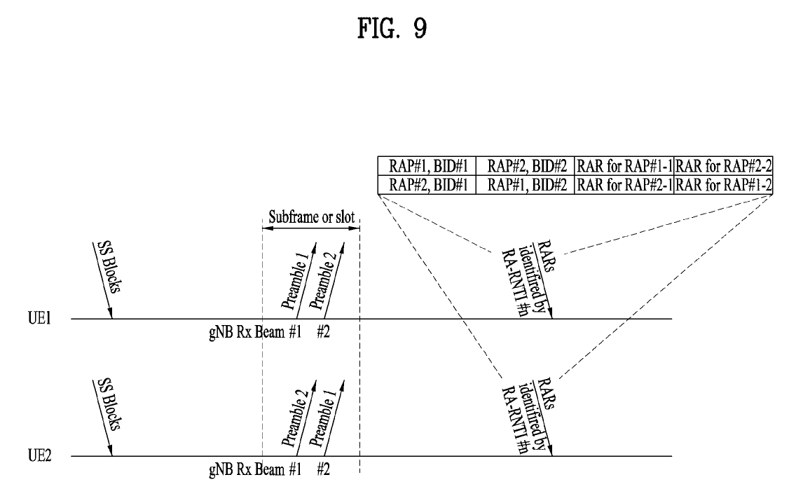

FIG. 9 illustrates an RA procedure at UEs according to an embodiment of the present invention. Referring to FIG. 9, the UE behavior in the proposed scheme 1 may be as follows. In FIG. 9, BID denotes a beam index, and RAR for RAP#x-y denotes RAR for preamble x and gNB Rx beam y.

In FIG. 9, UE1 and UE2 receive the SS blocks and system information. Based on the system information, UE1 and UE2 can get the gNB Rx beam indices for RACH resources. UE1 and UE2 select the same gNB Tx beam (i.e., same SS block index) based on the DL measurement. Based on the DL measurement and corresponding SS block to RACH resource association, UEs transmit multiple/different preambles within a subframe informed by a gNB without any preamble collision.

UE1 and UE2 successfully receive its RAR message by detecting the information of preamble and beam pairs in the RAR MAC PDU.

Scheme 2. A New Scheme of RA-RNTI Computation Considering the Proposed Index (e.g., gNB Rx Beam Index)

In Scheme 2 of the present invention, the RARs for the multiple/different preambles transmitted within a single RA procedure are identified by the different RA-RNTIs. For example, the proposed RA-RNTI can be computed as follows:

RA-RNTI=1+t_id+Wₘₐₓ*f_id+Wₘₐₓ*Fₘₐₓ*b_id

where t_id is the index of the first subframe of the specified PRACH (0≤t_id<10) in a radio frame, and f_id is the index of the specified PRACH within that subframe, in ascending order of frequency domain (0≤f_id<6) and Wₘₐₓ is maximum possible RAR window size in subframes. Fₘₐₓ is the maximum frequency domain size (it may be 6) and b_id is the beam/symbol/logical index of the specified RACH resource (i.e. the specified PRACH) (0≤b_id<14), in ascending order of time domain within a subset of RACH resources.

In this Scheme 2, RARs for multiple preambles which are transmitted on the different RACH resources (for gNB Rx beams) within a subframe are identified by the RA-RNTI.

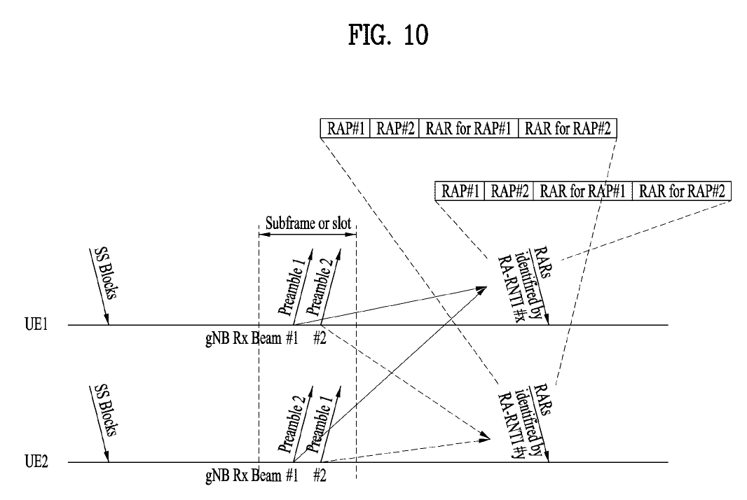

FIG. 10 illustrates an RA procedure at UEs according to another embodiment of the present invention. Referring to FIG. 10, the UE behavior in the proposed scheme 2 may be as follows. In FIG. 10, RA-RNTI #x denotes RA-RNTI calculated using a proposed index of a RACH resource associated with a gNB Rx beam #1 (e.g., a corresponding gNB Rx beam index, symbol index or logical index of the RACH resource associated with gNB Rx beam #1), and RA-RNTI #y denotes RA-RNTI calculated using a proposed index of a RACH resource associated with a gNB Rx beam #2 (e.g., a corresponding gNB Rx beam index, symbol index or logical index of the RACH resource associated with gNB Rx beam #2).

In FIG. 10, UE1 and UE2 receive the SS blocks and system information. Based on the system information, UE1 and UE2 can get the gNB Rx beam indices for RACH resources (or corresponding symbols or logical indices associated with the gNB Rx beam indices). UE1 and UE2 may select the same gNB Tx beam based on the DL measurement. Based on the DL measurement and corresponding association between SS blocks and RACH resources, UEs transmit multiple/different preambles within a subframe informed by gNB without any preamble collision. UE1 and UE2 successfully receive its RAR message by blind decoding DCI addressed to the different RA-RNTIs. For example, referring to FIG. 10, If UE1 and UE2 transmit preamble 1 and preamble 2, respectively, using a same RACH resource #a, UE1 and UE2 may monitor PDCCH addressed to RA-RNTI #x calculated using the proposed index of the RACH resource #a as well as the time/frequency index of the RACH resource #a. UE1 may identify RAR for RAP#1 among RARs identified by RA-RNTI #x, and UE2 may identify RAR for RAP#2 among RARs identified by RA-RNTI #x.

If a gNB can form multiple gNB Rx beams in a same OFDM symbol, i.e., if the gNB can receive UL transmissions in different directions simultaneously, the gNB may associate a same RACH resource with different gNB Rx beams according to UEs in order to perform efficient UL scheduling. If an OFDM symbol index of a RACH resource is used as the proposed index of the present invention, the gNB may inform a UE of a gNB Rx beam index used in the OFDM symbol index of the RACH resource. For example, a gNB may associate an OFDM symbol of a RACH resource with a gNB Rx beam #1 for UE1 and the same OFDM symbol of the RACH resource with a gNB Rx beam #2 for UE2. The gNB may inform a UE of association information between RACH resources and gNB Rx beams for the UE. If the gNB detects a PRACH of the UE, the gNB may transmit an RAR PDCCH addressed to a RA-RNTI calculated using the time/frequency index of the PRACH, the OFDM symbol index of the PRACH and a gNB Rx beam index of the PRACH. The UE may calculate RA-RNTI using a gNB Rx beam index associated with a RACH resource used for PRACH transmission in addition to the time/frequency index of the RACH resource. The UE may perform PDCCH monitoring with the RA-RNTI to receive an RAR corresponding to the PRACH.

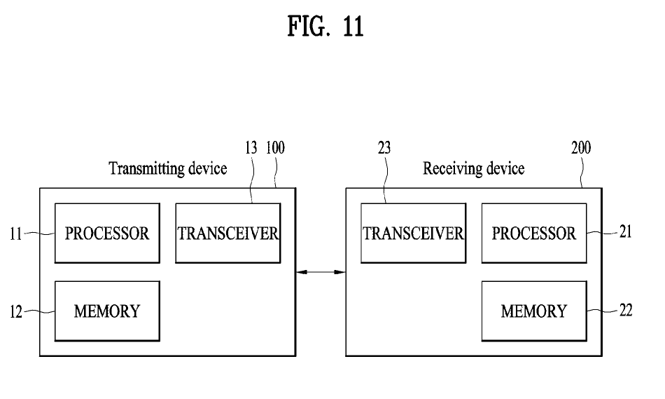

FIG. 11 is a block diagram illustrating elements of a transmitting device 100 and a receiving device 200 for implementing the present invention.

The transmitting device 100 and the receiving device 200 respectively include Radio Frequency (RF) units 13 and 23 capable of transmitting and receiving radio signals carrying information, data, signals, and/or messages, memories 12 and 22 for storing information related to communication in a wireless communication system, and processors 11 and 21 operationally connected to elements such as the transceivers 13 and 23 and the memories 12 and 22 to control the elements and configured to control the memories 12 and 22 and/or the transceivers 13 and 23 so that a corresponding device may perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 generally control the overall operation of various modules in the transmitting device and the receiving device. Especially, the processors 11 and 21 may perform various control functions to implement the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 100 performs predetermined coding and modulation for a signal and/or data scheduled to be transmitted to the outside by the processor 11 or a scheduler connected with the processor 11, and then transfers the coded and modulated data to the transceiver 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the transceiver 13 may include an oscillator. The transceiver 13 may include Nₜ (where Nₜ is a positive integer) transmit antennas.

A signal processing process of the receiving device 200 is the reverse of the signal processing process of the transmitting device 100. Under control of the processor 21, the transceiver 23 of the receiving device 200 receives radio signals transmitted by the transmitting device 100. The transceiver 23 may include Nᵣ (where Nᵣ is a positive integer) receive antennas and frequency down-converts each signal received through receive antennas into a baseband signal. The processor 21 decodes and demodulates the radio signals received through the receive antennas and restores data that the transmitting device 100 intended to transmit.

The transceivers 13 and 23 include one or more antennas. An antenna performs a function for transmitting signals processed by the transceivers 13 and 23 to the exterior or receiving radio signals from the exterior to transfer the radio signals to the transceivers 13 and 23.

The antenna may also be called an antenna port. Each antenna may correspond to one physical antenna or may be configured by a combination of more than one physical antenna element. The signal transmitted from each antenna cannot be further deconstructed by the receiving device 200. An RS transmitted through a corresponding antenna defines an antenna from the view point of the receiving device 200 and enables the receiving device 200 to derive channel estimation for the antenna, irrespective of whether the channel represents a single radio channel from one physical antenna or a composite channel from a plurality of physical antenna elements including the antenna. That is, an antenna is defined such that a channel carrying a symbol of the antenna can be obtained from a channel carrying another symbol of the same antenna. A transceiver supporting a MIMO function of transmitting and receiving data using a plurality of antennas may be connected to two or more antennas. The transceivers 13 and 23 may be referred to as radio frequency (RF) units.

In the embodiments of the present invention, a UE operates as the transmitting device 100 in UL and as the receiving device 200 in DL. In the embodiments of the present invention, a gNB operates as the receiving device 200 in UL and as the transmitting device 100 in DL. Hereinafter, a processor, a transceiver, and a memory included in the UE will be referred to as a UE processor, a UE transceiver, and a UE memory, respectively, and a processor, a transceiver, and a memory included in the gNB will be referred to as a gNB processor, a gNB transceiver, and a gNB memory, respectively.

The UE processor can be configured to operate according to the present invention, or control the UE transceiver to receive or transmit signals according to the present invention. The gNB processor can be configured to operate according to the present invention, or control the gNB transceiver to receive or transmit signals according to the present invention.

A gNB processor may control a gNB transceiver to transmit configuration information for random access channel (RACH) resources. A UE transceiver may receive configuration information for random access channel (RACH) resources. A UE processor may control the transceiver to transmit a first preamble of a random access procedure using a first RACH resource among the RACH resources based on the configuration information. In an example of the present invention, the UE processor may further control the transceiver to transmit control the transceiver to transmit a second preamble of the random access procedure using a second RACH resource among the RACH resources based on the configuration information.

The gNB processor may attempt to detect RACH preamble(s) in RACH resources configured according to the configuration information. If the gNB processor detects a RACH preamble in the first RACH resource, the gNB processor may transmit a RAR for the RACH preamble detected in the first RACH resource. The gNB processor may scramble a PDCCH carrying scheduling information of a PDSCH carrying the RAR, with an RA-RNTI (hereinafter first RA-RNTI) computed based on an index of a time unit of the first RACH resource among time units in a radio frame and an index of the first symbol (i.e. the earliest symbol) of the first RACH resource. If the gNB processor detects a RACH preamble in the second RACH resource, the gNB processor may transmit a RAR for the RACH preamble detected in the second RACH resource. The gNB processor may scramble a PDCCH carrying scheduling information of a PDSCH carrying the RAR, with an RA-RNTI (hereinafter second RA-RNTI) computed based on an index of a time unit of the second RACH resource among time units in a radio frame and an index of the first symbol (i.e. the earliest symbol) of the second RACH resource.

In the present invention, each time unit consists of 14 symbols in a time domain, and may be referred to as a slot or subframe. The index of the first symbol of the first RACH resource is a non-negative integer value smaller than 14.

The UE processor may monitor a RAR message of the random access procedure based on the first RA-RNTI. The UE processor may compute the first RA-RNTI based on an index of a time unit of the first RACH resource among time units in a radio frame and an index of the first symbol (i.e. earliest symbol) of the first RACH resource. The UE processor may further monitor a RAR message of the random access procedure based on the second RA-RNTI. The UE processor may further monitor a RAR message of the random access procedure based on the second RA-RNTI if the UE processor fails to detect the RAR message using the RA-RNTI.

The gNB processor may control the gNB transceiver to transmit association information between indexes of gNB receiving (Rx) beams and the RACH resources. The gNB processor may compute the first RA-RNTI based on an index of a first gNB Rx beam associated with the first RACH resource, the index of the time unit of the first RACH resource, the index of the first symbol of the first RACH resource and a frequency index of the first RACH resource. The UE processor may control the UE transceiver to receive the association information, and may compute the first RA-RNTI based on an index of a first gNB Rx beam associated with the first RACH resource, the index of the time unit of the first RACH resource, the index of the first symbol of the first RACH resource and the frequency index of the first RACH resource.

As described above, the detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

The embodiments of the present invention are applicable to a network node (e.g., BS), a UE, or other devices in a wireless communication system.

What is claimed are:

1. A method for monitoring a random access response (RAR) by a user equipment (UE) in a wireless communication system, the method comprising:
receiving configuration information for random access channel (RACH) resources;
transmitting a first preamble of a random access procedure using a first RACH resource among the RACH resources based on the configuration information; and
monitoring a RAR message of the random access procedure based on a first random access radio network temporary identifier (RA-RNTI),
wherein the first RA-RNTI is computed based on an index of a time unit of the first RACH resource and an index of the first symbol of the first RACH resource,
wherein each time unit consists of 14 symbols in a time domain, and
wherein the index of the first symbol of the first RACH resource is a non-negative integer value smaller than 14.

2. The method according to claim 1, further comprising:
transmitting a second preamble of the random access procedure using a second RACH resource among the RACH resources based on the configuration information; and
monitoring a RAR message of the random access procedure based on a second RA-RNTI,
wherein the second RACH resource is different from the first RACH resource,
wherein the second RA-RNTI is computed based on an index of a time unit of the second RACH resource and an index of the first symbol of the second RACH resource,
wherein the index of the first symbol of the second RACH resource is a non-negative integer value not larger than 14.

3. The method according to claim 1,
receiving association information between indexes of gNB receiving (Rx) beams and the RACH resources,
wherein the first RA-RNTI is computed based on an index of a first gNB Rx beam associated with the first RACH resource, the index of the time unit of the first RACH resource, the index of the first symbol of the first RACH resource and a frequency index of the first RACH resource.

4. A user equipment (UE) for monitoring a random access response (RAR) in a wireless communication system, the UE comprising:
a transceiver, and
a processor configured to control the transceiver, the processor configured to:
control the transceiver to receive configuration information for random access channel (RACH) resources;
control the transceiver to transmit a first preamble of a random access procedure using a first RACH resource among the RACH resources based on the configuration information; and
monitor a RAR message of the random access procedure based on a first random access radio network temporary identifier (RA-RNTI),
wherein the processor is configured to compute the first RA-RNTI based on an index of a time unit of the first RACH resource and an index of the first symbol of the first RACH resource,
wherein each time unit consists of 14 symbols in a time domain, and
wherein the index of the first symbol of the first RACH resource is a non-negative integer value smaller than 14.

5. The UE according to claim 4,
wherein the processor is configured to:
control the transceiver to transmit a second preamble of the random access procedure using a second RACH resource among the RACH resources based on the configuration information; and
monitor a RAR message of the random access procedure based on a second RA-RNTI,
wherein the second RACH resource is different from the first RACH resource,
wherein the processor is configured to compute the second RA-RNTI based on an index of a time unit of the second RACH resource and an index of the first symbol of the second RACH resource,
wherein the index of the first symbol of the second RACH resource is a non-negative integer value not larger than 14.

6. The UE according to claim 4,
wherein the processor is configured to:
control the transceiver to receive association information between indexes of gNB receiving (Rx) beams and the RACH resources,
wherein the processor is configured to compute the first RA-RNTI based on an index of a first gNB Rx beam associated with the first RACH resource, the index of the time unit of the first RACH resource, the index of the first symbol of the first RACH resource and a frequency index of the first RACH resource.

7. A method for transmitting a random access response (RAR) by a gNB in a wireless communication system, the method comprising:
transmitting configuration information for random access channel (RACH) resources;
receiving a preamble of a random access procedure using a RACH resource among the RACH resources based on the configuration information; and
transmitting a RAR message of the random access procedure based on a random access radio network temporary identifier (RA-RNTI),
wherein the RA-RNTI is computed based on an index of a time unit of the RACH resource and an index of the first symbol of the RACH resource,
wherein each time unit consists of 14 symbols in a time domain, and
wherein the index of the first symbol of the RACH resource is a non-negative integer value smaller than 14.

8. A method for transmitting a random access response (RAR) by a gNB in a wireless communication system, the method comprising:
a transceiver, and
a processor configured to control the transceiver, the processor configured to:
control the transceiver to transmit configuration information for random access channel (RACH) resources;
control the transceiver to receive a preamble of a random access procedure using a RACH resource among the RACH resources based on the configuration information; and
control the transceiver to transmit a RAR message of the random access procedure based on a random access radio network temporary identifier (RA-RNTI),
wherein the processor is configured to compute the RA-RNTI based on an index of a time unit of the RACH resource and an index of the first symbol of the RACH resource,
wherein each time unit consists of 14 symbols in a time domain, and
wherein the index of the first symbol of the RACH resource is a non-negative integer value smaller than 14.
